(19) United States
(12) Patent Application Publication
(10) Pub. No.: US 2017/0176033 A1
(43) Pub. Date: Jun. 22, 2017

(54) INTELLIGENT MISSION CRITICAL ENVIRONMENTAL MONITORING AND ENERGY MANAGEMENT SYSTEM

(71) Applicant: Archimedes Controls Corp., Pleasanton, CA (US)

(72) Inventors: Liangcai TAN, Dublin, CA (US); Wenli YU, Pleasanton, CA (US); Xin HU, Dublin, CA (US); Xiang LIU, San Francisco, CA (US); Fenghua GE, Shanghai (CN)

(73) Assignee: Archimedes Controls Corp., Pleasanton, CA (US)

(21) Appl. No.: 15/382,378

(22) Filed: Dec. 16, 2016

Related U.S. Application Data
(60) Provisional application No. 62/269,888, filed on Dec. 18, 2015.

(51) Int. Cl. F24F 11/00; G05B 19/048

(52) U.S. Cl. CPC F24F 11/006; F24F 11/0015; F24F 11/0012; G05B 19/048; F24F 2011/0075; F24F 2011/0061; G05B 2219/2614; G05B 2219/2642; G06F 21/31

(57) ABSTRACT

The present invention is a complete solution for mission critical facilities to create a safe environment and energy efficient CRAC system. The invented system collects mission critical facility volume environmental and energy data in real time, and uses big data analytics to provide adaptive group control to CRACs. The data is visualized in 2D and 3D graphs, dashboard, history curves and reports locally and through the cloud. The present invention also provides user management to allow authorized users to view and control the racks/servers owned or rented by these users. The present invention is comprised of four companion patents: 1) A Battery-powered Wireless Long Life Temperature and Humidity Sensor Module, 2) An Intelligent Multi-channel Wireless Data Acquisition Gateway, 3) Mission critical facility Three Dimension Temperature Contour Generator, and 4) An Adaptive Automatic CRAC Master Control Method.

### CROSS-REFERENCE TO RELATED APPLICATION

This application claims the benefit of U.S. Provisional Application No. 62/269,888, filed on Dec. 18, 2015, the entire contents of which is incorporated herein by reference.

### FIELD OF THE INVENTION

The present invention relates to internet of things (IoT) and big data analytics and, more particularly, to mission critical facilities internet of things and big data analytics.

### BACKGROUND OF THE INVENTION

For mission critical facilities a safe environment and high energy efficiency are two important factors to keep long facility life time for the facility owner. In reality most of the existing mission critical facilities can't provide a safe environment for its racks and servers with 100% guarantee. The facility mangers are worried about the facility failure over time. Most of the existing mission critical facilities also have low energy efficiency with power utilization efficiency (PUE, minimum value=1.0, the less the better) larger than 2.0. A safe environment and energy efficiency system starts from sensors in every corner of the mission critical facility, to data transmission and analysis in the data gateway and server, to feedback control of computer room air conditioners (CRAC). Every step needs thoughtful planning to form a complete solution for mission critical facilities. There are no products in the market providing such a complete solution. There are three types of products in the market to fulfill some of the tasks. The first type is wireless sensor networks. The second type is data visualization software programs. The third type is energy management controllers or software programs. A few companies provide wireless sensor networks for measure temperature, humidity and other environmental parameters. In these wireless sensor networks the data can be transmitted by a predefined interval but users can't change its frequency or add local data analysis function. Most of these products use power adaptor so installation is an issue. Some of them use battery but the sensor life is limited to 1 to 5 years. A couple of them have more than 10 years of life but with limited flexibility and significant higher cost. There are many companies providing data visualization software programs to collect data from installed sensors and make the data graphically display to users. However these products don't know or don't care what sensors really measure and parameters mean. These data visualization software programs can attract some users in the beginning but seldom last long time due to its lack of feedback loop controlling of the computer room air conditioner (CRAC) system. A few CRAC and building automation system (BAS) vendors provide energy management controllers and software programs. These controllers or programs use traditional single area average return temperature to control the running of local CRACs. This method is lack of consideration of spatial environmental parameters so it is biased and inaccurate in some cases. A couple of companies claimed that they provided a complete solution but when dug into details it was found that they are either lack of intelligent local data analysis and alarming function, or certain parameters like relative humidity, or cloud-based service.

It would be advantageous to provide a complete feedback system with sensors, data collectors, data visualization and adaptive controller.

It would also be advantageous to provide an independent system which can be applied to servers, racks and CRACs from any vendors.

It would further be advantageous to provide a mechanism to collect volume thermal sensor data (both temperature and relative humidity) by using an intelligent multi-channel wireless sensor network.

It would further be advantageous to provide a unique mission critical facility three dimension dynamic temperature contour generator to visualize the thermal environment and show hot and cold spots.

It would further be advantageous to provide an adaptive automatic CRAC group control method.

It would further be advantageous to provide user management to allow authorized users to view and control the racks/equipment owned or rented by these users.

### SUMMARY OF THE INVENTION

In accordance with the present invention, there is provided a complete solution for mission critical facilities to create a safe environment and energy efficient CRAC system. The invented system collects mission critical facility volume environmental and energy data in real time, and uses big data analytics to provide adaptive group control to CRACs. The data is visualized in 2D and 3D graphs, dashboard, history curves and reports locally and through the cloud. The present invention also provides user management to allow authorized users to view and control the racks/servers owned or rented by these users. The present invention is comprised of four companion patents: 1) A Battery-powered Wireless Long Life Temperature and Humidity Sensor Module, 2) An Intelligent Multi-channel Wireless Data Acquisition Gateway, 3) Mission critical facility Three Dimension Temperature Contour Generator, and 4) An Adaptive Automatic CRAC Master Control Method.

In some embodiments, an intelligent mission critical environmental monitoring and energy management system for monitoring mission critical environments with volume sensors, and using the measured data for visualization, alarming, fault detection and controlling of computer room air conditioners to ensure safe environment and energy efficiency, comprises: one or more systems for sensing environmental data, conducting local data analysis and transmitting it to a database server; one or more systems for systematically analyzing volume sensor data, visualizing 3D data and using measured data to implement feedback control; one or more systems for visualizing data in the cloud and implementing cloud level control strategies; one or more systems for collecting temperature and relative humidity data simultaneously and wireless transmitting the temperature and relative humidity data to the intelligent gateway; one or more systems for acquiring and processing sensor data, and transmitting data to the database server through various communication protocols, connected to at least one of the one or more systems for collecting temperature and relative humidity data simultaneously and wireless transmitting the data to the intelligent gateway; one or more systems for measuring air speed, firmly mounted to at least one of the one or more systems for acquiring and processing sensor data, and transmitting data to the database server through various communication protocols; one or more systems for measuring particulate matter, firmly mounted to at least one of the one or more systems for acquiring and processing sensor data, and transmitting data to the database server through various communication protocols; one or more systems for receiving and transmitting the data package from the intelligent gateway to the database server, continuously connected to at least one of the one or more systems for acquiring and processing sensor data, and transmitting data to the database server through various communication protocols; one or more systems for collecting data from various sensors and organizing the data into the correct database tables, continuously connected to at least one of the one or more systems for receiving and transmitting the data package from the intelligent gateway to the database server; one or more systems for providing internet information services to client station/terminal browsers, concurrently interconnected to at least one of the one or more systems for collecting data from various sensors and organizing the data into the correct database tables; one or more systems for providing user interactive display of measured data, calculated indices and processed data in various formats interconnected to said the one or more systems for providing internet information services to client station/terminal browsers; one or more systems for automatically controlling each CRAC's on/off, return temperature set point and fan speed, concurrently interconnected to at least one of the one or more systems for providing internet information services to client station/terminal browsers; one or more systems for providing data storage and processing for the data arrived from mission critical facilities distributed in the world, safely interconnected to at least one of the one or more systems for collecting data from various sensors and organizing the data into the correct database tables; one or more systems for providing user interactive display of measured data, calculated indices and processed data interconnected to at least one of the one or more systems for providing data storage and processing for the data arrived from mission critical facilities distributed in the world; one or more systems for providing user interactive data display similar to client browser, safely interconnected to at least one of the one or more systems for providing data storage and processing for the data arrived from mission critical facilities distributed in the world; and one or more systems for providing user management to allow authorized users to view and control the racks equipment of the users.

In some embodiments, the one or more systems for sensing environmental data, conducting local data analysis and transmitting it to the database server comprises sensors, gateways, routers, and a hardware data acquisition system. In some embodiments, the one or more systems for systematically analyzing volume sensor data, visualizing 3D data and using the measured data to implement feedback control comprises a data analyzer, a web server, an adaptive group controller, a terminal browser local display and a control system. In some embodiments, the one or more systems for visualizing data in the cloud and implementing cloud level control strategies comprises a cloud database, software and applications, a big data analytics cloud based display and a control system. In some embodiments, the one or more systems for collecting temperature and relative humidity data simultaneously and wireless transmitting the data to the intelligent gateway comprises a rigid, wireless, long life, battery powered temperature and humidity sensor module.

In some embodiments, the one or more systems for acquiring and processing sensor data, and transmitting data to the database server through various communication protocols comprises a wireless, multi-channel, multi-protocol, multi-sensor intelligent gateway. In some embodiments, the one or more systems for measuring air speed comprises a part of an intelligent gateway air speed sensor. In some embodiments, the one or more systems for measuring particulate matter comprises a part of the intelligent gateway PM sensor. In some embodiments, the one or more systems for receiving and transmitting the data package from the intelligent gateway to the database server comprises a with WIFI protocol, with Ethernet protocol router.

In some embodiments, the one or more systems for collecting data from various sensors and organizing the data into the correct database tables comprises a MySQL database, daemon, local area network database server. In some embodiments, the one or more systems for providing internet information services to client station/terminal browsers comprises an internet information services, local area network web server. In some embodiments, the one or more systems for providing user interactive display of measured data, calculated indices and processed data in various formats comprises a terminal browser compatible with Internet Explorer, Google Chrome and Firefox. In some embodiments, the one or more systems for automatically controlling each CRAC's on/off, return temperature set point and fan speed, concurrently interconnected to at least one of the one or more systems for providing internet information services to client station/terminal browsers comprises software comprising an adaptive algorithm to control a group of CRACs adaptive group controller. In some embodiments, at least one of the one or more systems for providing data storage and processing for the data arrived from mission critical facilities distributed in the world comprises an Internet, remote, daemon cloud server. In some embodiments, at least one of the one or more systems for providing user interactive display of measured data, calculated indices and processed data in various formats comprises a client browser. In some embodiments, at least one of the one or more systems for providing user interactive data display similar to a client browser comprises a mobile device application.

In some embodiments, an intelligent mission critical environmental monitoring and energy management system for monitoring mission critical environments with volume sensors and using the measured data for visualization, alarming, fault detection and controlling of computer room air conditioners to ensure safe environment and energy efficiency, comprises: sensors, gateways and routers, and a hardware data acquisition system, for sensing environmental data, conducting local data analysis and transmitting it to the database server; a data analyzer, a web server, an adaptive group controller, a terminal browser local display and a control system, for systematically analyzing volume sensor data, visualizing 3D data and using the measured data to implement feedback control; a cloud database, software and applications, a big data analytics cloud based display and controller, for visualizing data in the cloud and implementing cloud level control strategies; a rigid, wireless, long life, battery powered temperature and humidity sensor module, for collecting temperature and relative humidity data simultaneously and wireless transmitting the data to the intelligent gateway; a wireless, multi-channel, multi-protocol, multi-sensor intelligent gateway, for acquiring and processing sensor data, and transmitting data to the database server through various communication protocols, coordinately connected to said temperature and humidity sensor module; an air speed sensor as part of the intelligent gateway, for measuring air speed, firmly mounted to said intelligent gateway; a PM sensor part of the intelligent gateway, for measuring particulate matter, firmly mounted to said intelligent gateway; a router with WIFI and Ethernet protocol, for receiving and transmitting the data package from the intelligent gateway to the database server, continuously connected to said intelligent gateway; a MySQL, daemon, local area network database server, for collecting data from various sensors and organizing the data into the correct database tables, continuously connected to said router; an internet information services, local area network web server, for providing internet information services to client station/terminal browsers, concurrently interconnected to said database server; a terminal browser compatible with Internet Explorer, Google Chrome, and Firefox, for providing user interactive display of measured data, calculated indices and processed data in various formats interconnected to said web server; a software program stored on a non-transitory storage medium, comprising an adaptive algorithm to control group of CRACs, adaptive group controller, for automatically controlling each CRAC's on/off, return temperature set point and fan speed to secure the mission critical facility thermal environment concurrently interconnected to said web server; a user management system to allow authorized users to view and control the racks/equipment; an internet based, remote, daemon cloud server, for providing data storage and processing for the data arrived from mission critical facilities distributed in the world, interconnected to said database server; a client browser software program stored on a non-transitory storage medium for providing user interactive display of measured data, calculated indices and processed data in various formats interconnected to said cloud server; and a mobile device application, for providing a user interactive data display interconnected to said cloud server.

### BRIEF DESCRIPTION OF THE DRAWINGS

A complete understanding of the present invention may be obtained by reference to the accompanying drawings, when considered in conjunction with the subsequent, detailed description, in which:

FIG. 1 is a detail view of a system typology.

For purposes of clarity and brevity, like elements and components will bear the same designations and numbering throughout the FIGURES.

### DETAILED DESCRIPTION OF THE INVENTION

The present invention is an intelligent mission critical environmental monitoring and energy management system for monitoring mission critical environments with volume sensors, and using the measured data for visualization, alarming, fault detection and controlling of computer room air conditioners to ensure safe environment and energy efficiency, comprising a data acquisition system 100, a local display and control system 200 and cloud based display and control 300.

The data acquisition system 100 is a group of sensors, gateways and routers, for sensing environmental data, conducting local data analysis and transmitting it to the database server 210. It is comprised of a group of temperature and humidity sensor modules 110, intelligent gateways 120, air speed sensors 121, particulate matter (PM) sensors 122, routers 130, BAS data 150, and power meter 140.

The temperature and humidity sensor module 110 is rigid, wireless, long life, battery powered, for collecting temperature and relative humidity data simultaneously, and wireless transmitting the data to the intelligent gateway 120.

The intelligent gateway 120 is wireless, multi-channel, multi-protocol, multi-sensor, for acquiring and processing sensor data, and transmitting data to the database server 210 through various communication protocols, coordinately connected to said temperature and humidity sensor module 110.

The air speed sensor 121 is part of the intelligent gateway 120, for measuring air speed, firmly mounted to said intelligent gateway 120.

The PM sensor 122 is part of the intelligent gateway 120, for measuring particulate matter, firmly mounted to said intelligent gateway 120.

The router 130 is with WIFI protocol, with Ethernet protocol, for receiving and transmitting the data package from the intelligent gateway 120 to the database server 210, continuously connected to said intelligent gateway 120.

The BAS data 150 is building automation system data, for supplying electrical and CRAC data to the database server 210 for integrated analysis, continuously connected to said router 130.

The power meter 140 is installed in racks or column of racks, for measuring electrical power and energy consumption of individual/group racks and CRACs, continuously connected to said router 130.

The local display and control system 200 is comprised of data analyzer, web server 220, adaptive group controller 230, terminal browser 250, for systematically analyzing volume sensor data, visualizing 3D data vividly and using the measured data to implement feedback control.

The database server 210 is a MySQL database and daemon in a local or wide area network, for collecting data from various sensors and organizing the data into the correct database tables, continuously connected to said router 130.

The web server 220 is in a local or wide area network, for providing internet information services to client station/terminal browsers, concurrently interconnected to said database server 210. The web server also provides user management to allow authorized users to view and control the racks/equipment owned or rented by these users.

The terminal browser 250 is compatible with Internet Explorer, Google Chrome and Firefox, for providing user interactive display of measured data, calculated indices and processed data in various formats such as 2D and 3D graphs, dashboard, historical curves, tables, reports, etc., safely interconnected to said web server 220.

The adaptive group controller 230 is a software program, using adaptive algorithm to control group of CRACs, for automatically controlling each CRAC's on/off, return temperature set point and fan speed, to secure the mission critical thermal environment for server's secure running and optimizing the energy use, concurrently interconnected to said web server 220.

The computer room air conditioner 240 is the control object, for providing cooling, heating, ventilation, humidification and dehumidification to the mission critical facility, coordinately connected to said adaptive group controller 230;

The cloud based display and control 300 is cloud database, software and apps, big data analytics, for visualizing data in the cloud and implementing cloud level control strategies. It is comprised of the cloud server 310, client browser 320 and mobile app 330.

The cloud server 310 is an internet server and a remote daemon, for providing data storage, and processing for the data arrived from mission critical facilities distributed in the world, safely interconnected to said database server 210. The cloud server also provides user management to allow authorized users to view and control the racks/equipment owned or rented by these users.

The client browser 320 is a browser based software program, can be located anywhere, for providing user interactive display of measured data, calculated indices and processed data in various formats such as 2D and 3D graphs, dashboard, historical curves, tables, reports, etc., safely interconnected to said cloud server 310.

The mobile app 330 a mobile device application, for providing user interactive data display similar to the client browser 320, safely interconnected to said cloud server 310.

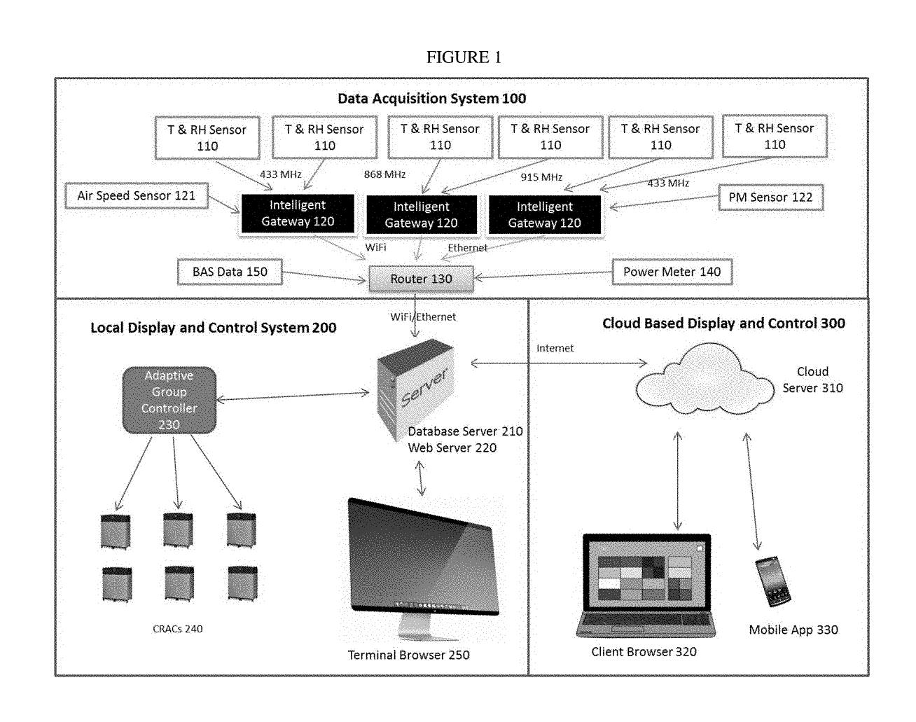

FIG. 1 is a detail view of a system typology.

In some embodiments, the described systems and methods can be implemented using one or more computer systems. The system can be a microprocessor-based device, such as a personal computer, workstation, server, handheld computing device such as a phone or tablet, or distributed computing system (e.g., cloud computing system). The system can include, for example, one or more processors, communication devices, input devices, output devices, storage, and/or software stored on storage and executable by the processors. The components of the computer can be connected in any suitable manner, such as via one or more physical buses or wirelessly.

In some embodiments, the system may include server-side computing components as well as client-side computing components. In some embodiments, some or all components may be part of a distributed computing system (e.g., a cloud computing system). In some embodiments of the techniques disclosed herein, for example, storage may be storage provisioned by a cloud computing system, such that a user may send instructions to the cloud computing system over one or more network connections, and the cloud computing system may execute the instructions in order to leverage the cloud computing components in accordance with the instructions. In some embodiments, cloud computing systems may be configured to be capable of executing the same or similar program code in the same programming languages as other systems (e.g., servers, personal computers, laptops, etc.) as discussed herein.

The processors may be any suitable type of computer processor capable of communicating with the other components of system in order to execute computer-readable instructions and to cause the system to carry out actions in accordance with the instructions. For example, the processors may access a computer program (e.g., software) that may be stored on storage and execute the program to cause the system to perform various actions in accordance with the program. In some embodiments, a computer program or other instructions executed by the processors may be stored on any transitory or non-transitory computer-readable storage medium readable by the processors.

A communication device may include any suitable device capable of transmitting and receiving signals over a network, such as a network interface chip or card. System may be connected to a network, which can be any suitable type of interconnected communication system. The network can implement any suitable communications protocol and can be secured by any suitable security protocol. The network can comprise network links of any suitable arrangement that can implement the transmission and reception of network signals, such as wireless network connections, T1 or T3 lines, cable networks, DSL, or telephone lines.

An input device may be any suitable device that provides input, such as a touch screen or monitor, keyboard, mouse, button or key or other actuatable input mechanism, microphone and/or voice-recognition device, gyroscope, camera, or IR sensor. An output device may be any suitable device that provides output, such as a touch screen, monitor, printer, disk drive, light, speaker, or haptic output device.

Storage can be any suitable device the provides storage, such as an electrical, magnetic or optical memory including a RAM, cache, hard drive, CD-ROM drive, tape drive or removable storage disk.

Software, which may be stored in storage and executed by the processors, may include, for example, the programming that embodies the functionality of the methods, techniques, and other aspects of the present disclosure (e.g., as embodied in the computers, servers and devices as described above). In some embodiments, software may include a combination of servers such as application servers and database servers.

Software can also be stored and/or transported within any computer-readable storage medium for use by or in connection with an instruction execution system, apparatus, or device, such as those described above, that can fetch instructions associated with the software from the instruction execution system, apparatus, or device and execute the instructions. In the context of this disclosure, a computer-readable storage medium can be any medium that can contain or store programming for use by or in connection with an instruction execution system, apparatus, or device.

Software can also be propagated within any transport medium for use by or in connection with an instruction execution system, apparatus, or device, such as those described above, that can fetch instructions associated with the software from the instruction execution system, apparatus, or device and execute the instructions. In the context of this disclosure, a transport medium can be any medium that can communicate, propagate or transport programming for use by or in connection with an instruction execution system, apparatus, or device. The transport readable medium can include, but is not limited to, an electronic, magnetic, optical, electromagnetic or infrared wired or wireless propagation medium.

The system can implement any one or more operating systems suitable for operating on the network. Software 112 can be written in any one or more suitable programming languages, such as C, C++, Java or Python. In various embodiments, application software embodying the functionality of the present disclosure can be deployed in different configurations, such as in a client/server arrangement or through a Web browser as a Web-based application or Web service, for example.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the techniques and their practical applications. Others skilled in the art are thereby enabled to best utilize the techniques and various embodiments with various modifications as are suited to the particular use contemplated.

Although the disclosure and examples have been fully described with reference to the accompanying FIGURES, it is to be noted that various changes and modifications will become apparent to those skilled in the art. Such changes and modifications are to be understood as being included within the scope of the disclosure and examples as defined by the claims.

What is claimed is:

1. An intelligent mission critical environmental monitoring and energy management system for monitoring mission critical environments with volume sensors, and using the measured data for visualization, alarming, fault detection and controlling of computer room air conditioners to ensure safe environment and energy efficiency, comprising:
one or more systems for sensing environmental data, conducting local data analysis and transmitting it to a database server;
one or more systems for systematically analyzing volume sensor data, visualizing 3D data and using measured data to implement feedback control;
one or more systems for visualizing data in the cloud and implementing cloud level control strategies;
one or more systems for collecting temperature and relative humidity data simultaneously and wireless transmitting the temperature and relative humidity data to the intelligent gateway;
one or more systems for acquiring and processing sensor data, and transmitting data to the database server through various communication protocols, connected to at least one of the one or more systems for collecting temperature and relative humidity data simultaneously and wireless transmitting the data to the intelligent gateway;
one or more systems for measuring air speed, firmly mounted to at least one of the one or more systems for acquiring and processing sensor data, and transmitting data to the database server through various communication protocols;
one or more systems for measuring particulate matter, firmly mounted to at least one of the one or more systems for acquiring and processing sensor data, and transmitting data to the database server through various communication protocols;
one or more systems for receiving and transmitting the data package from the intelligent gateway to the database server, continuously connected to at least one of the one or more systems for acquiring and processing sensor data, and transmitting data to the database server through various communication protocols;
one or more systems for collecting data from various sensors and organizing the data into the correct database tables, continuously connected to at least one of the one or more systems for receiving and transmitting the data package from the intelligent gateway to the database server;
one or more systems for providing internet information services to client station/terminal browsers, concurrently interconnected to at least one of the one or more systems for collecting data from various sensors and organizing the data into the correct database tables;
one or more systems for providing user interactive display of measured data, calculated indices and processed data in various formats interconnected to said the one or more systems for providing internet information services to client station/terminal browsers;
one or more systems for automatically controlling each CRAC's on/off, return temperature set point and fan speed, concurrently interconnected to at least one of the one or more systems for providing internet information services to client station/terminal browsers;
one or more systems for providing data storage and processing for the data arrived from mission critical facilities distributed in the world, safely interconnected to at least one of the one or more systems for collecting data from various sensors and organizing the data into the correct database tables;
one or more systems for providing user interactive display of measured data, calculated indices and processed data interconnected to at least one of the one or more systems for providing data storage and processing for the data arrived from mission critical facilities distributed in the world;
one or more systems for providing user interactive data display similar to client browser, safely interconnected to at least one of the one or more systems for providing data storage and processing for the data arrived from mission critical facilities distributed in the world; and
one or more systems for providing user management to allow authorized users to view and control the racks equipment of the users.

2. The intelligent mission critical environmental monitoring and energy management system in accordance with claim 1, wherein the one or more systems for sensing environmental data, conducting local data analysis and transmitting it to the database server comprises sensors, gateways, routers, and a hardware data acquisition system.

3. The intelligent mission critical environmental monitoring and energy management system in accordance with claim 1, wherein the one or more systems for systematically analyzing volume sensor data, visualizing 3D data and using the measured data to implement feedback control comprises a data analyzer, a web server, an adaptive group controller, a terminal browser local display and a control system.

4. The intelligent mission critical environmental monitoring and energy management system in accordance with claim 1, wherein the one or more systems for visualizing data in the cloud and implementing cloud level control strategies comprises a cloud database, software and applications, a big data analytics cloud based display and a control system.

5. The intelligent mission critical environmental monitoring and energy management system in accordance with claim 1, wherein the one or more systems for collecting temperature and relative humidity data simultaneously and wireless transmitting the data to the intelligent gateway comprises a rigid, wireless, long life, battery powered temperature and humidity sensor module.

6. The intelligent mission critical environmental monitoring and energy management system in accordance with claim 1, wherein the one or more systems for acquiring and processing sensor data, and transmitting data to the database server through various communication protocols comprises a wireless, multi-channel, multi-protocol, multi-sensor intelligent gateway.

7. The intelligent mission critical environmental monitoring and energy management system in accordance with claim 1, wherein the one or more systems for measuring air speed comprises a part of an intelligent gateway air speed sensor.

8. The intelligent mission critical environmental monitoring and energy management system in accordance with claim 1, wherein the one or more systems for measuring particulate matter comprises a part of the intelligent gateway PM sensor.

9. The intelligent mission critical environmental monitoring and energy management system in accordance with claim 1, wherein the one or more systems for receiving and transmitting the data package from the intelligent gateway to the database server comprises a with WIFI protocol, with Ethernet protocol router.

10. The intelligent mission critical environmental monitoring and energy management system in accordance with claim 1, wherein the one or more systems for collecting data from various sensors and organizing the data into the correct database tables comprises a MySQL database, daemon, local area network database server.

11. The intelligent mission critical environmental monitoring and energy management system in accordance with claim 1, wherein the one or more systems for providing internet information services to client station/terminal browsers comprises an internet information services, local area network web server.

12. The intelligent mission critical environmental monitoring and energy management system in accordance with claim 1, wherein the one of the one or more systems for providing user interactive display of measured data, calculated indices and processed data in various formats comprises a terminal browser compatible with Internet Explorer, Google Chrome and Firefox.

13. The intelligent mission critical environmental monitoring and energy management system in accordance with claim 1, wherein the one of the one or more systems for automatically controlling each CRAC's on/off, return temperature set point and fan speed, concurrently interconnected to at least one of the one or more systems for providing internet information services to client station/terminal browsers comprises software comprising an adaptive algorithm to control a group of CRACs adaptive group controller.

14. The intelligent mission critical environmental monitoring and energy management system in accordance with claim 1, wherein the one of the one or more systems for providing data storage and processing for the data arrived from mission critical facilities distributed in the world comprises an internet, remote, daemon cloud server.

15. The intelligent mission critical environmental monitoring and energy management system in accordance with claim 1, wherein the one or more systems for providing user interactive display of measured data, calculated indices and processed data in various formats comprises a client browser.

16. The intelligent mission critical environmental monitoring and energy management system in accordance with claim 1, wherein at least one of the one or more systems for providing user interactive data display similar to a client browser comprises a mobile device application.

17. An intelligent mission critical environmental monitoring and energy management system for monitoring mission critical environments with volume sensors and using the measured data for visualization, alarming, fault detection and controlling of computer room air conditioners to ensure safe environment and energy efficiency, comprising:
sensors, gateways and routers, and a hardware data acquisition system, for sensing environmental data, conducting local data analysis and transmitting it to the database server;
a data analyzer, a web server, an adaptive group controller, a terminal browser local display and a control system, for systematically analyzing volume sensor data, visualizing 3D data and using the measured data to implement feedback control;
a cloud database, software and applications, a big data analytics cloud based display and controller, for visualizing data in the cloud and implementing cloud level control strategies;
a rigid, wireless, long life, battery powered temperature and humidity sensor module, for collecting temperature and relative humidity data simultaneously and wireless transmitting the data to the intelligent gateway;
a wireless, multi-channel, multi-protocol, multi-sensor intelligent gateway, for acquiring and processing sensor data, and transmitting data to the database server through various communication protocols, coordinately connected to said temperature and humidity sensor module;
an air speed sensor as part of the intelligent gateway, for measuring air speed, firmly mounted to said intelligent gateway;
a PM sensor part of the intelligent gateway, for measuring particulate matter, firmly mounted to said intelligent gateway;
a router with WIFI and Ethernet protocol, for receiving and transmitting the data package from the intelligent gateway to the database server, continuously connected to said intelligent gateway;
a MySQL, daemon, local area network database server, for collecting data from various sensors and organizing the data into the correct database tables, continuously connected to said router;
an internet information services, local area network web server, for providing internet information services to client station/terminal browsers, concurrently interconnected to said database server;
a terminal browser compatible with Internet Explorer, Google Chrome, and Firefox, for providing user interactive display of measured data, calculated indices and processed data in various formats interconnected to said web server;
a software program stored on a non-transitory storage medium, comprising an adaptive algorithm to control group of CRACs, adaptive group controller, for automatically controlling each CRAC's on/off, return temperature set point and fan speed to secure the mission critical facility thermal environment concurrently interconnected to said web server;
a user management system to allow authorized users to view and control the racks/equipment;
an internet based, remote, daemon cloud server, for providing data storage and processing for the data arrived from mission critical facilities distributed in the world, interconnected to said database server;
a client browser software program stored on a non-transitory storage medium for providing user interactive display of measured data, calculated indices and processed data in various formats interconnected to said cloud server; and
a mobile device application, for providing a user interactive data display interconnected to said cloud server.
